(19) United States
(12) Patent Application Publication
(10) Pub. No.: US 2026/0261481 A1
(43) Pub. Date: Sep. 3, 2026

(54) MANAGEMENT DATA ANALYTICS (MDA) REPORTING

(71) Applicant: Intel Corporation, Santa Clara, CA (US)

(72) Inventors: Yizhi Yao, Chandler, AZ (US); Joey Chou, Scottsdale, AZ (US)

(21) Appl. No.: 18/880,928

(22) PCT Filed: Jul. 24, 2023
(86) PCT No.: PCT/US2023/028440

§ 371 Date: Jan. 3, 2025

Related U.S. Application Data
(60) Provisional application No. 63/394,837, filed on Aug. 3, 2022.

(51) Int. Cl. H04L 41/14

(52) U.S. Cl. CPC H04L 41/14

(57) ABSTRACT

An apparatus and system are described for multiple methods of Management Data Analytics (MDA) reporting. A Management Data Analytics Service (MDAS) producer receives a request to create a Managed Object Instance (MOI) for an MDA request. The MDAS producer creates the MOI for the MDA request, responds to an MDAS consumer about a result of creation of the MOI, and performs MDA. The MDAS producer then makes a subscription for a reporting target based on a reporting method selected from a plurality of reporting methods or establishes a streaming connection with the reporting target, creates an MDA report based on the MDA, and sends the MDA report to a reporting target per the reporting method.

### PRIORITY CLAIM

This application claims the benefit of priority to U.S. Provisional Patent Application Ser. No. 63/394,837, filed Aug. 3, 2022, which is incorporated herein by reference in its entirety.

### TECHNICAL FIELD

Embodiments pertain to 5^{th} generation (5G) wireless communications. In particular, some embodiments relate to management data analytics reporting in 5G networks.

### BACKGROUND

The use and complexity of next generation (NG) systems, which include 5G networks and are starting to include sixth generation (6G) networks among others, has increased due to both an increase in the types of devices user equipment (UEs) using network resources as well as the amount of data and bandwidth being used by various applications, such as video streaming, operating on these UEs. With the vast increase in number and diversity of communication devices, the corresponding network environment has become increasingly complicated. As expected, a number of issues abound with the advent of any new technology, including complexities related to management data analytics and reporting.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a management data analytics (MDA) request and reporting workflow in accordance with some embodiments.

FIG. 4 illustrates a process of providing an MDA report in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

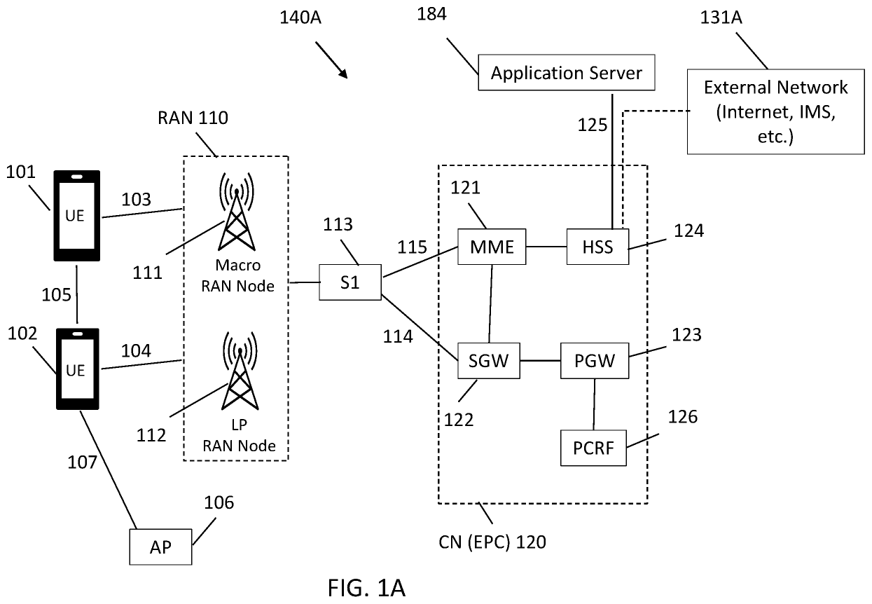

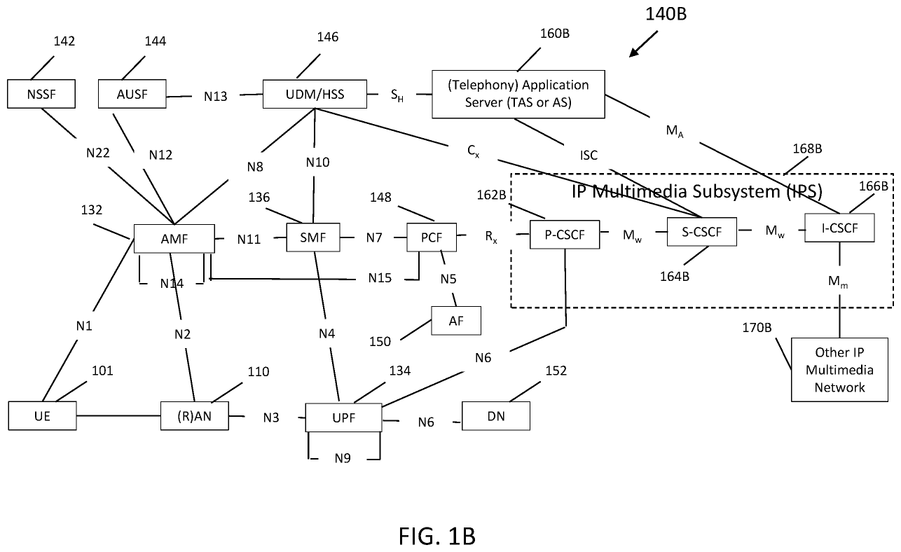

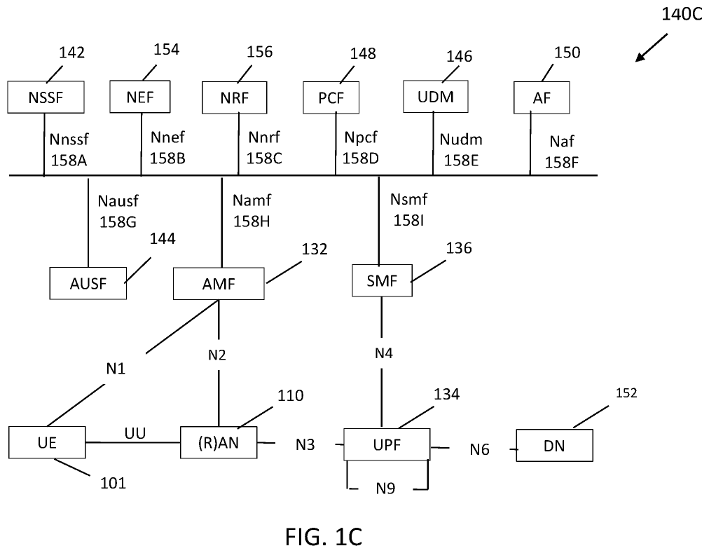

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g., an IMS operated by a different network operator.

In some aspects, the UDM/HSS 146 can be coupled to an application server 184, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

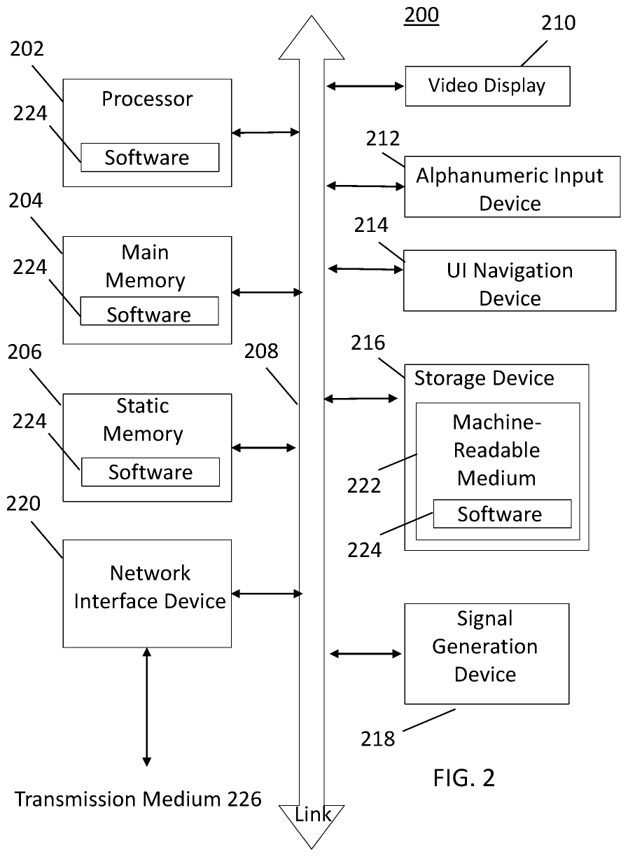

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Management Data Analytics (MDA) is useful for mobile networks and services management and orchestration as an enabler of automation and intelligence. MDA provides processing and analyzing data capabilities related to network and service events and status, including performance measurements, key performance indicators (KPIs), Trace/minimization of drive test (MDT)/radio link failure (RLF)/RRC Connection Establishment Failure (RCEF) reports, quality of experience (QoE) reports, alarms, configuration data, network analytics data, and service experience data from application functions (AFs), etc. to provide analytics output, i.e. statistics or predictions, root cause analysis issues, and may also include recommendations to enable actions for network and service operations.

The MDA output is provided by the Management Data Analytics Service (MDAS) producer to the corresponding consumer(s) that requested the analytics. The MDA can identify ongoing issues impacting the performance of the network and services and help to identify in advance potential issues that may cause potential failure and/or performance degradation.

The MDA can also assist to predict the network and service demand to enable the timely resource provisioning and deployments which would allow fast time-to-market network and service deployments.

MDAS, the services exposed by the MDA, can be consumed by various consumers, including for instance management functions (MnFs) (i.e., management service (MnS) producers/consumers for network and service management), NFs (e.g., Network Data Analytics Function (NWDAF)), self-organized network (SON) functions, network and service optimization tools/functions, Service Level Specification (SLS) assurance functions, human operators, and AFs, etc.

A management function (MDAF) may play the roles of MDA MnS producer, MDA MnS consumer, other MnS consumer, NWDAF consumer and LMF service consumer, and may also interact with other non-3GPP management systems.

An MDA MnS producer provides analytics with respect to a particular network context, i.e., network status, under which data is collected to produce analytics. For example, a prediction of load in an area of interest may differ when all gNBs and potential additional RATs are operating compared to case where certain gNBs or other RATs are experiencing a fault or are powered off to save energy. The analytics conducted and produced by the MDA MnS producer for these two example scenarios would be different and directly affected by the specific status of network. Although the network status (context) affects the produced analytics conducted by the MDA producer, awareness of the network context would fall on the consumer side to complement the obtained analytics results. This network context, reflecting network status at the time of enabling data collection, is important for the MDA MnS consumer to understand the network conditions related to the obtained analytics and hence be able to use such analytics more efficiently.

The MDA MnS consumer cannot expect the MDA producer to provide the network context, because the network context interest of each MDA MnS consumer may differ depending on the usage and purpose of analytics. The usage can include a proprietary algorithm that assist a decision-making process. For example, a load balancing algorithm may use the load and mobility information among neighboring gNBs whereas other load balancing algorithms may also use load and mobility information from a greater geographical area. In addition, the selection of the parameters and their combinations may prove to be impractical for the MDA MnS producer to prepare and provide. Hence, it is efficient for the MDA MnS producer to prepare only the MDA output without including any network context and allow the MDA MnS consumer to obtain the desired network context, to complement the obtained analytics, using configuration management procedures as described in TS 28.511 and TS 28.531.

Intelligence in Analytics, played by MDA, in the management loop which can be open loop (operator controlled) or closed loop (autonomous), generates value by processing and analysis of management and network data, where AI and ML techniques may be utilized.

The management loop constitutes number of elements including the analytics, and these are briefly described as:

Observation: The observation of the managed networks and services. It involves monitoring and collection of events, status and performance of the managed networks and services, and providing the observed/collected data.

Analytics: The data analytics for the managed networks and services. MDA plays the role of Analytics in the management loop. It prepares, processes and analyses the observed/collected data or time series of the observed/collected data related to the managed networks and services. MDA reports may contain root cause analysis of ongoing issues, predictions of potential issues and corresponding relevant causes and recommended actions for preventions, and/or prediction of network and/or service demands.

Decision: The decision making for the management actions for the managed networks and services. The management actions are decided based on the analytics reports (provided by MDA) and other management data (e.g., historical decisions made previously) if necessary. The decision may be made by the consumer of MDAS (in the closed management control loop), or by a human operator (in the case of open management loop). The decision may include e.g. what actions to take, and when to take the actions. Execution: The execution of the management actions according to the decisions. During the execution step, the actions are carried out to the managed networks and services, and the reports (e.g., notifications, logs) of the executed actions are provided.

MDA use cases, requirements, data definitions, information models, MnS are defined in 3GPP TS 28.104, v. 17.0.1. The service components of the MDA MnS are also provided in TS 28.104.

### 10 MIDA Related Service Components

### 10.1 MDA MnS Service Components

### 10.1.1 General

The MDA MnS service components are defined below for both MDA request and control and for MDA reporting taking into consideration the requirements defined in clause 7.3, the MDA capability data definitions in clause 8 and information models for MDA defined in clause 9.

### 10.1.2 MDA Report Request and Control

### 10.1.2.1 Service Components

TABLE 10.1.2.1-1
Components of MDA MnS for MDA request and control

| | | Management |
|---|---|---|
| Management | Management service component | service component |
| service | type A | type B |
| MnS for MDA | The operations and notifications | MDARequest IOC |
| request and | can be referred to in TS 28.532 | defined in |
| control | [2]. Which can be supported | clause 9.3.2. |
| | by all use cases. | |
| | Operation: | |
| | createMOI | |
| | getMOIAttributes | |
| | modifyMOIAttributes | |
| | deleteMOI | |
| | Notification: | |
| | notifyMOICreation | |
| | notifyMOIDeletion | |
| | notifyMOIAttributeValueChanges | |
| | notifyEvent | |
| | notifyMOIChanges | |

### 10.1.3 MDA Reporting

### 10.1.3.1 Service Components

TABLE 10.1.3.1-1
Components of MDA MnS for MDA reporting

| | Management | Management | Management |
|---|---|---|---|
| | service | service | service |
| Management | component | component | component |
| service | type A | type B | type C |
| MnS for | The operations and notifications | MDAReport | The file |
| MDA | in TS 28.532 [2], clause 11.6 are | IOC defined | containing |
| reporting - | applicable and shall be supported | in clause 9. | the content |
| File based | for all MDA capabilities. | | defined by |
| reporting | Operations: | | MDAReport |
| | subscribe | | IOC with the |
| | unsubscribe | | format |
| | listAvailableFiles | | specified in |
| | Notifications: | | clause A.2.2. |
| | notifyFileReady | | |
| | notifyFilePreparationError | | |
| MnS for | The operations and notifications | MDAReport | The stream |
| MDA | in TS 28.532 [2], clause 11.5 are | IOC defined | data |
| reporting - | applicable and shall be supported | in clause 9. | containing |
| Streaming | for all MDA capabilities. | | the content |
| based | Operations: | | defined by |
| reporting | establishStreamingConnection | | MDAReport |
| | terminateStreamingConnection | | IOC with the |
| | reportStreamData | | format |
| | addStream | | specified in |
| | deleteStream | | clause A.2.2. |
| | getConnectionInfo | | |
| | getStreamInfo | | |
| MnS for | The following operations and | MDAReport | |
| MDA | notifications in TS 28.532 [2], | IOC defined | |
| reporting - | clause 11.1 are applicable and | in clause 9. | |
| NRM | shall be supported for all MDA | | |
| notification | capabilities. | | |
| based | Operations: | | |
| reporting | getMOIAttributes | | |
| | Notifications: | | |
| | notifyMOICreation | | |
| | notifyMOIDeletion | | |
| | notifyMOIChanges | | |

Three methods are allowed for MDA reporting. The workflow (as specified in TS 28.104) only supports one option, however. Among other things, embodiments herein help provide an MDA workflow with all of the allowed reporting methods to provide a complete picture for the workflow of MDA requesting and reporting.

An MDA workflow is presented for MDA requesting and reporting, with all allowed reporting methods considered.

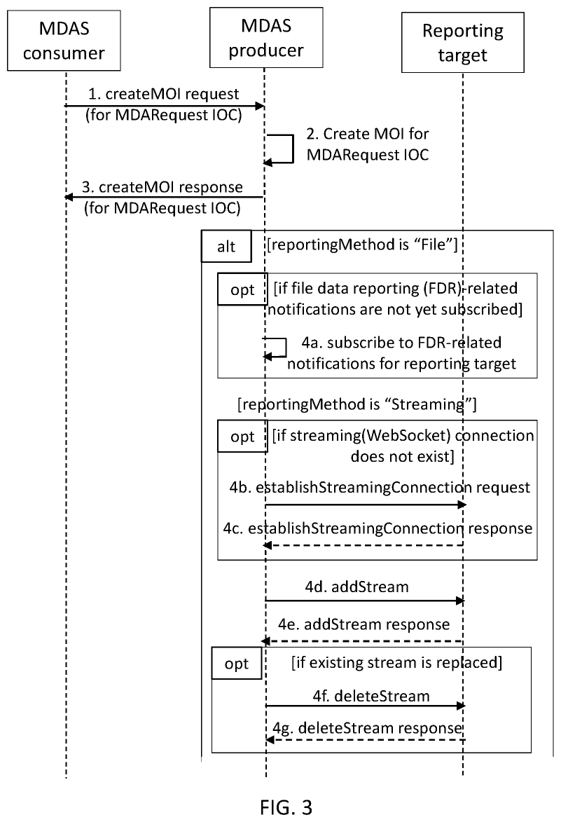

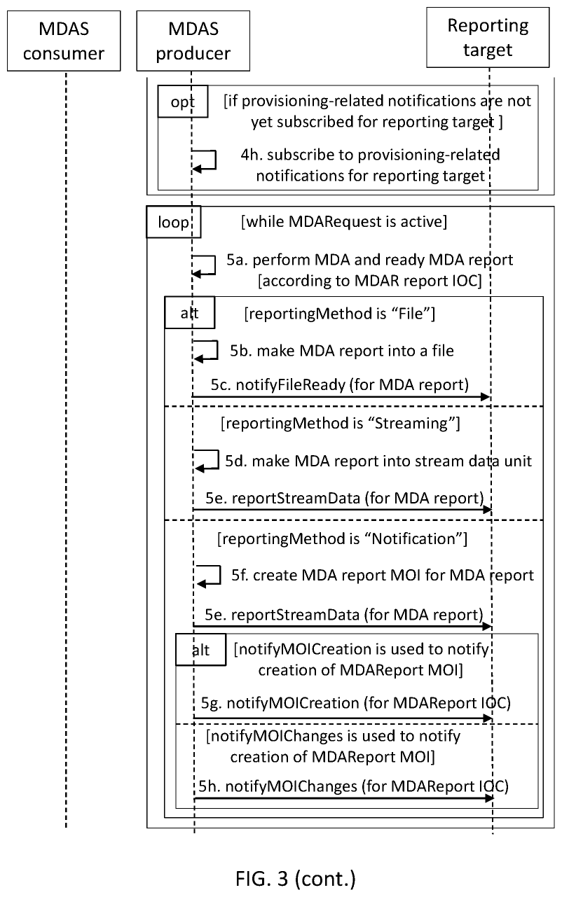

FIG. 3 illustrates an MDA request and reporting workflow in accordance with some embodiments.

### 1. MDA Request and Reporting Workflow

1. MDAS Producer receives a createMOI (see createMOI operation defined in TS 28.532, v. 17.1.1, 2022 Jun. 22) request from an authorized MDAS Consumer to create an MDARequest MOI (see clause 9).

2. The MDAS Producer creates the MOI for the MDARequest IOC per the createMOI request.

3 The MDAS Producer sends the createMOI response to the MDAS Consumer with DN of the MOI.

4 The MDAS producer subscribes to the relevant notifications or setup the streaming connections, per the selected reporting method (identified by reportingMethod attribute in the MDARequest MOI):

If the reportingMethod designated in the MDARequest MOI is “File”: 4a. if subscription for the reporting target (specified by the reportingTarget attribute in the MDARequest MOI) do not exist, the MDAS producer subscribes to the file data reporting related notifications (see TS 28.532) for the reporting target.

If the reportingMethod designated in the MDARequest MOI is “Streaming”: 4b/4c. if the streaming connection with the reporting target does not exist, the MDAS producer invokes the establishStreamingConnection operation (see TS 28.532) to setup the streaming connection with the streaming target; 4d/4e. The MDAS producer invokes the addStream operation (see TS 28.532) to add the stream for the expected MDA reports. 4f/4g. If the newly added stream is to replace an existing one, the MDAS producer invokes the deleteStream operation (see TS 28.532) to delete the stream.

If the reportingMethod designated in the MDARequest MOI is “Notification”: 4h. If subscription for the reporting target do not exist, the MDAS producer subscribes to the provisioning related notifications (see TS 28.532) for the reporting target.

5. While the MDARequest is active, the MDAS Producer keeps performing MDA, and making the MDA report (see the MDAReport IOC defined in clause 9) according to the MDARequest MOI.

5a. the MDAS producer makes the MDA report ready and sends the MDA report to the reporting target per the selected reporting method (identified by reportingMethod attribute in the MDARequest MOI):

If the reportingMethod designated in the MDARequest MOI is “File”:

5b. the MDAS producer makes the MDA report into a file.

5c. the MDAS producer emits the notifyFileReady notification (see TS 28.531) to the reporting target for the MDA report.

If the reportingMethod designated in the MDARequest MOI is “Streaming”:

5d. the MDAS producers makes the MDA report into a stream data unit.

5e. invokes the reportStreamData operation (see TS 28.531) to the reporting target for the MDA report.

If the reportingMethod designated in the MDARequest MOI is “Notification”:

5f. the MDAS producer creates an MDAReport MOI (see clause 9) for the MDA report.

5g. if notifyMOICreation is used, the MDAS producer emits the notifyMOICreation notification (see TS 28.531) to the reporting target for the MDA report.

5h. if notifyMOIChanges is used, the MDAS producer emits the notifyMOIChanges notification (see TS 28.531) to the reporting target for the MDA report.

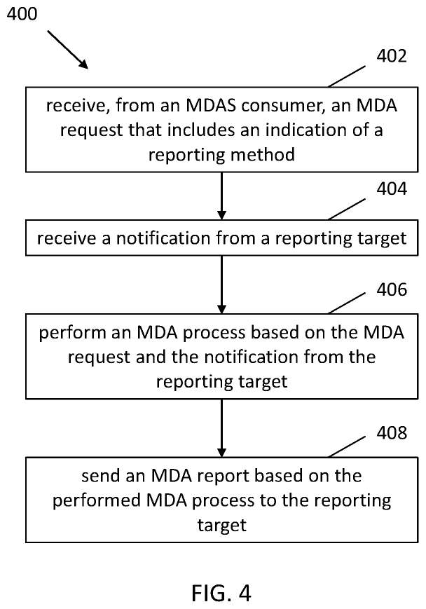

In some embodiments, the electronic devices, networks, systems, chips or components, or portions or implementations thereof, of the above figures may be configured to perform one or more processes, techniques, or methods as described herein, or portions thereof. One such process that may be performed by a MDAS producer is depicted in FIG. 4. FIG. 4 illustrates a process 400 of providing an MDA report in accordance with some embodiments. For example, the process 400 may include, at operation 402, receiving, from an MDAS consumer, an MDA request that includes an indication of a reporting method. At operation 404, the process 400 may further include receiving a notification from a reporting target. At operation 406, the process 400 may further include performing an MDA process based on the MDA request and the notification from the reporting target. At operation 408, the process 400 may further include sending an MDA report based on the performed MDA process to the reporting target.

### Use Cases:

### Coverage Related Analytics:

Coverage problem analysis: The RAN coverage problem may cause UEs to be out of service or result in a downgrade of network performance offered to the UEs, such as failure of random access, paging, RRC connection establishment or handover, low data throughput, abnormal releases of RRC connection or UE context, and dissatisfied QoE.

There are various types of coverage problems, e.g., weak coverage, a coverage hole, a pilot pollution, an overshoot coverage, or a DL and UL channel coverage mismatch, etc., caused by different sorts of reasons, such as insufficient or weak transmission power, blocked by constructions and/or restricted by terrain.

The 5G related coverage problem may exist in NR, in E-UTRA or both.

To unravel a coverage problem, the MDAS consumer determines the details about when and where the problem occurred or likely to occur, and the type and cause(s) of the problem. Therefore, it is desirable for MDA to correlate and analyze multifold data (such as performance measurements, MDT reports, RLF reports, RCEF reports, UE location reports, together with the geographical, terrain and configuration data of the RAN) to detect and describe the problem with detailed information.

The RAN coverage related problems can cause network performance degradation and in the extreme cases can result into service degradation. So besides identifying the problems after they have happened, proactive avoidance of the RAN coverage related problems well before they occur is desirable.

To avoid coverage related problems or to proactively undertake actions to avoid their occurrence, the consumer of MDA MnS may wish to know the characteristics and quality of the coverage of the RAN. This may be expressed graphically on a Map, called a Radio Environment Map, that shows the coverage quality for a set of cells. Such a map may be constructed e.g., to show the RSRP or the SINR of the cells as derived from the observed UE performance and/or from radio configuration parameters of the cells including transmit powers, antenna gains, antenna tilts, etc. It is desirable that the MDAS producer can provide the Radio Environment Map in an appropriate graphical form.

Moreover, where a new RAN node is provisioned, the MDAS producer should be able to take into considerations the coverage of existing cells as defined by a Radio Environment Map and derive the configuration of the new cell(s) and the existing cells to optimize the coverage. Image analytics should help to identify the most optimized set of initial radio configurations that can be assigned to a new RAN NE.

To help MDAS consumer to solve the coverage problem as quickly as possible, MDA may also provide, along with the description of the problem, the recommended remedy actions (e.g., reconfigure or add cells, beams, antennas, etc.).

### Slice Coverage Analysis:

The slice coverage is one of the indicators when a 3rd party (i.e., slice tenant) issues a slice request and is mapped into the desired geographical coverage area with the available radio coverage which depends on the base station planning and deployment. In order to map the desired slice coverage perfectly, MDA can be used to optimize the slice coverage on the slice instantiation and runtime considering:
i) slice-aware statistics, e.g., slice-UE distributions and mobility patterns;
ii) slice SLA; and
iii) access node capabilities.

In 5G the notion of coverage is represented by a set of one or more Tracking Areas (TAs), which are contained in a Registration Area (RA), which is assigned to a UE once it registers to the network. Depending on the MDA MnS producer output, TA and RA planning, i.e., grouping cells to form a TA and then TAs to an RA, can be optimized and the RAN parameters can be adjusted to shape the cell edges and load distribution. The main objective is to fulfill a given slice SLA involving as few cells as possible by leveraging the benefits of adjusting cell configurations for satisfying the desired coverage.

### Paging Optimization Analysis:

This MDA capability is for enabling various functionalities related to paging optimization. If the UE goes Out-Of-Coverage (OOC) the paging which was initiated by the network AMF fails. The re-attempts continue to fail until UE enters the coverage and respond to the paging attempts. This repetitive paging attempts result in the wastage of network resources. As an example, the use case includes a user or a group of users getting into an area, with no cellular coverage on a regular basis for a considerably long duration, for e.g., the user gets into a shielded room for some testing purpose every day for a defined period. The Network initiated paging for such users will fail until they are back in the area with cellular coverage. This would result in in-efficient network resource usage.

It is desirable to use MDAS to optimize the current paging procedures in 5G networks. MDAS producer provides an analytics output containing the user(s) paging analytics indicating the time window at which a group of users are OOC on a regular basis at the particular location. MDAS producer also provides the geographical map within which the UEs would experience paging issues and hence will not be able to respond on a network-initiated paging. Based on the provided MDA output, MDAS consumer (e.g., AMF, gNB) decides on whether, when and where to initiate or not to initiate the paging procedures, thereby ensuring the efficient paging procedures and optimal network resource utilization, as paging can be initiated only when there are more chances for it to be successful.

### SLS Analysis

Service experience of end user is a key indicator that directly reflects the user satisfaction degree. In 5G system, the diversity of network services is expanding all the time and the requirements of different services especially from vertical users are being standardized. Considering these diverse requirements and expectation from end user perspective (e.g., priorities of SLA related attributes such as latency, throughput, maximum number of users or different required values of these attributes), the service experience as a comprehensive indicator need to be extensively analyzed.

### Network Slice Throughput Analysis

Throughput is of great importance which represents the end users' experiences and also reflects the network problems, e.g., low UE throughput may be caused by resource shortage. MDAS may be utilized for throughput related analysis/predictions for network slice instance. MDAS producer allows the consumer to request analytics of network slice throughput related issues and identify the corresponding root cause(s) to assist throughput assurance. Network slice throughput analysis can be for a specific domain and/or for cross-domain. The two level MDAS producers, i.e., domain-specific and cross-domain may work in coordination to assure the optimum throughput performance.

### Network Slice Traffic Prediction

It is desirable to use MDAS to get the network slice traffic predictions including individual traffic load predictions on each of the constituent network function instance present in the network slice. The traffic load predictions per constituent network function instances can be used for better resource provisioning of the network slice. For example, resources can be pre-configured considering the predicted traffic on the network slice.

### E2E Latency Analysis

E2E latency is an important parameter for URLLC services. User data packets should be successfully delivered within certain time constraints to satisfy the end users requirements. Latency could be impacted by the network capability and network configurations. These factors may be the root cause if the latency requirements cannot be achieved. Packet transmission latency may dynamically change if these factors change. The latency requirement should be assured even if some of the network conditions may degrade. It is important for the MDAS producer to analyze the latency related issues to support SLS assurance.

### Network Slice Load Analysis

Network slice load may vary during different time periods. Therefore, network resources allocated initially could not always satisfy the traffic requirements, for example, the network slice may be overloaded or underutilized. Overload of signaling in control plane and/or user data congestion in user plane will lead to underperforming network. Besides, allocating excessive resources for network slice with light load will decrease resource efficiency.

The analysis of network slice load should consider the load of services with different characteristics (e.g., QoS information, service priority), load distribution to derive the corresponding resource requirements. Load distribution analytic result may be provided, e.g., load distribution for network slices, different locations and/or time periods etc.

Traffic and resources related performance measurements and UE measurements can be utilized by MDAS producer to identify degradation of the performance measurements and KPI documented in an SLS due to load issues, e.g., radio resource utilization. MDAS producer may further provide recommendations to the network slice load issue. This analytics results can be considered as an input to support SLA assurance to perform further evaluation.

### MDA Assisted Fault Management

There are multiple sources of faults which may cause the 5G system to fail to provide the expected service. These faults and the associated failures need extensive troubleshooting. In order to reduce network and service failure time and performance degradation, it is desirable to supervise the status of various network functions and resources and predict the running trend of network and potential failures to intervene in advance. These predictions can be used by the management system to autonomously maintain the health of the network, e.g., speedy recovery actions on a network function related to the predicted potential failure.

Due to the fact that failure prediction could depend on the existing alarm incidents and relevant historical and real-time data (performance measurement information, configuration data, network topology information, etc.), there is a possibility for MDA to be used in conjunction with AI/ML technologies and model training to predict potential failures. In order to avoid the occurrence of failures and abnormal network status, it is desirable for consumers of analytics to obtain the desired details of potential failure and the corresponding degradation trend (abnormal KPI, performance measurement information, possible alarm type, fault root cause, etc.). Therefore, MDA, may in conjunction with AI/ML technology, be required to obtain basic health maintenance knowledge (e.g., the relationship between the failures or potential failures and the related maintenance actions) through predefined expertise or model training, so as to effectively predict potential failures. The basic health maintenance knowledge could be updated with feedback. If desired, MDA could also provide corresponding recommended actions for failure prevention.

### Energy Saving Analysis

Operators are aiming at decreasing power consumption in 5G networks to lower their operational expense with energy saving management solutions. Energy saving is achieved by activating the energy saving mode of the NR capacity booster cell or 5GC NFs (e.g., UPF etc.). The energy saving decision making is based on the load information of the related cells/UPFs, the energy saving policies set by operators and the energy saving recommendations provided by MDAS producer. To achieve an optimized balance between the energy consumption and the network performance, MDA can be used to assist the MDAS consumer to make energy saving decisions.

To make the energy saving decision, it is desirable for MDAS consumer to determine where the energy efficiency issues (e.g., high energy consumption, low energy efficiency) exist, and the cause of the energy efficiency issues. Therefore, it is desirable for MDA to correlate and analyze the energy saving related performance measurements (e.g., PDCP data volume of cells, power consumption, etc.) and the network analysis data (e.g., observed service experience related network data analytics) to provide the analytics results which indicate current network energy efficiency. In some low-traffic scenarios, MDA MnS consumers may expect to reduce energy consumption to save energy. In this case, the MDA MnS consumer may request the MDAS producer to report only high energy consumption issue related analytics results. When the consumer expects to improve energy efficiency, although it may lead to high energy consumption in network or in certain parts of network, then the related issue is the low energy efficiency one. In that case, the consumer may request analytics results related to low energy efficiency issue. So, the target could be to enhance the performance of NF for a given energy consumption. This will result in higher Energy Efficiency of network.

To make the energy saving decision, it is necessary for MDAS consumer to determine which Energy Efficiency (EE) KPI related factor(s) (e.g., traffic load, end-to-end latency, active UE numbers, etc.) are affected or potentially affected. The MDAS producer can utilize historical data to predict the EE KPI related factors (e.g., load variation of cells at some future time, etc.). The prediction result of these information can then be used by operators to make energy-saving decision to guarantee the service experience. The MDAS producer may also provide energy saving related recommendation with the energy saving state to the MDAS consumer. Under the energy saving state, the desired network performance and network experience should be guaranteed. Therefore, it is desirable to formulate appropriate energy saving policies (start time, dynamic threshold setting, base station parameter configuration, etc.). The MDAS consumer may take the recommendations with the energy saving state into account for making analysis or making energy saving decisions. After the recommendations have been executed, the MDA producer may start evaluating and further analyzing network management data to optimize the recommendations.

### Mobility Performance Analysis

The mobility performance related problems may result from too-early/too-late/ping-pong handovers due to inappropriate handover parameters. MDAS can be used to analyze service experience and network performance during handover period in different mobility scenarios. MDAS producer may also be capable to provide the recommendations of optimal handover parameters to MDAS consumer.

In different NSA and SA deployment architecture scenarios, handover mechanisms (e.g., DAPS, CHO or RACH-less handover) will have different impacts on the mobility performance. The analytics report to identify the most optimal handover mechanism may be provided by MDAS producer.

### Handover Optimization Analysis

### Handover Optimization

Current handover procedures are mainly based on radio conditions for selecting the target gNB upon a handover. The target gNB accepts or rejects the Handover (HO) request depending on various conditions. In virtualized environment, the HO may be rejected due to inadequate available resources within the target gNB. The notion of resources may include virtual resources (e.g., compute, memory) and/or radio resources (e.g., PRB, RRC connected users). If the HO request is rejected, a UE will try to connect to a different gNB until the request is successfully accepted. Several target gNBs can be tried until the request is successfully accepted. This process can result in wastage of UE and network resources, while it may also introduce service disruption due to increased latency and Radio Link Failures (RLFs). It also introduces inefficiency in the HO or other network procedures.

To address this handover optimization issue, it is desirable to use MDA (Management Data Analytics) to provision and/or select a particular target gNB for handover in order to reduce or even avoid HO rejections. The MDAS producer provides a HO optimization analytics output containing the current and future/predicted resource consumption, resources capabilities and other KPI status for the available target gNB(s). The analytics output also provides recommended actions to optimize the target gNB for handover. This may include resource re-configuration or the updated selection criteria for target gNB. Based on the output, the MDAS consumer adjusts (e.g., scale-out/up the virtual resource, re-schedule/optimize radio resource) the resources before continuing with the handover and/or adjusts the selection criteria of the target gNB by also considering the overlapping coverages of inter-frequency and inter-RAT deployments.

### Handover Optimization Based on UE Load

The target node, eNB, may not have adequate resources to accept certain handover requests. In the context of network virtualization, these resources may include not only legacy radio resources, but also virtual resources such as processor and memory. Handover optimization can benefit from knowledge about the projected UE load on the target cell including additional radio and virtual resources.

### Inter-gNB Beam Selection Optimization

With the deployment of 5G networks, Massive MIMO has been used on a large scale. Beamforming, as a key technology to reduce user interference, which can suppress interference signals in non-target directions and enhance sound signals in target directions, is always combined with Massive MIMO to further decrease interference. A cell can make use of multiple beams for serving residing users (SSB or CSI-RS) with each user served by a single beam at a time. The cell level quality can be represented as an aggregated metric over one or more beams. So, although handover is performed between two 5G cells, the granularity of handover can be further broken down to beam level.

The handover of beams could be performed if the network resource or the user's state have changed to obtain better network performance. Beam optimization includes the handover between different beams and configuration of beam parameters.

In order to avoid selecting the wrong beam to perform RACH on the target cell and causing RLF of the UE, MDA can be used to recommend a means to prioritize and/or select the beam in case of handover for a specific target cell. MDA can provide a beam level HO optimization analysis considering information on the handover performance of different beam combinations between the source and target cell pairs. Beams of the target cell with a successful handover are preferred in the selection.

MDA could also provide recommended actions and priority options for beam selection. Based on the recommended actions, the MDA MnS consumer adjusts the priorities for the beam selection at HO, i.e., the beam combinations that are likely to succeed are prioritized, less optimal beam combinations are down prioritized. The target cell may also obtain analytics to allocate RACH resources in a way that ensures HO success.

In order to optimize antenna and beam configuration, so as to reduce energy loss and enhance network performance, MDA can be used to analyze the current network status.

### MDA Assisted Critical Maintenance Management

### RAN Node Software Upgrade

As per the current mechanism of software upgrade at RAN node results in service disruption or huge operational cost. Consider a scenario, when a RAN Node is required to shut down manually to undergo critical maintenance for a very short duration of time. Software upgrade can be one such critical maintenance scenario. In such cases, all the resources (bearer, security functions, mobility management) that are managed by this RAN Node need to be purged and reconfigured at another RAN Node (standby RAN Node) or if another RAN Node is not available then resources will be reconfigured again when former RAN Node comes up after software upgrade. Both the situations lead to additional operational expenses and data loss. Operational expense in terms of all the resources to be released/attached again and data loss for all GBR sessions/bearer.

It is expected to use MDAS to optimize the procedure of software upgrade at RAN Node by providing the right time to execute the upgrade. The software upgrade should be automatically initiated by the OAM system, once configured, during the time frame when the expected impacts are minimum i.e., at the optimal time when there would be minimum expected operational cost and data loss. The Optimal Time (current or futuristic) can be derived by collecting and analyzing the data related to DRBs including GBR/non-GBR, state, modification count, ongoing handover etc. MDAS can utilize historical data and AI/ML (e.g., time series based) algorithm to derive the future optimal time frame for software upgrade.

### MDA MnS

The MDA MnS consumer can request the MDA MnS producer to provide MDA output for a list of specified MDA type of analytics, i.e., MDA type, which corresponds to an MDA capability, which is to support analytics for a set of data or analytics for a certain PM, KPI, trace or QoE data. The MDA MnS consumer may introduce control attributes related to the MDA output with respect to the geographical location (i.e., area scope) and/or the target objects, e.g., managed elements, time schedule for obtaining an MDA output, time conditions related to the preparation of MDA output (i.e., time schedule for start, end and duration of analytics, etc.), and potential filter conditions to be met before an MDA output is made available, e.g. load or delay threshold crossing related to a target object. The geographical location indicates an area of interest for obtaining MDA output and/or target objects include affected objects or objects of interest for obtaining MDA output.

The MDA MnS consumer may control the MDA output attributes related to, e.g., time schedule, geographical location, target objects, etc., and has the capability to modify them at any point in time. The MDA MnS consumer can request the MDA MnS producer to generate an MDA output that contains numeric output results, e.g., average, normal distribution, etc., recommendation options, e.g., potential handover target cells, or root cause analysis, e.g., alarm prediction.

The MDA MnS consumer can be informed with an acknowledgment if the request was successful. If the request was not successful, the consumer is informed about potential errors indicating the reasons. The MDA MnS consumer can also deactivate the MDA reporting control request once it is no longer needed.

### Obtaining MDA Output

The MDA MnS producer allow consumers to obtain MDA output when the conditions indicated in the MDA request are met. The level of details and granularity of MDA output results would depend on the MDA request and nature of MDA capability. Therefore, an MDA output can vary in complexity and may contain one or more MDA results, which may be:
i) numeric, e.g., average, etc.;
ii) recommendation options, e.g., potential handover target cells; or
iii) root cause analysis, e.g., alarm prediction.

These results may be related to one or more MDA types, which correspond to MDA capabilities, and can also contain information regarding the time schedule or the validity time of the provided MDA output.

MDA MnS producer may allow consumers to request and obtain different MDA output results. The MDA MnS producer may also allow consumers to obtain information regarding the geographical location and/or the target objects, e.g., managed elements, related to the provided MDA result—from the corresponding element.

The MDA MnS producer may allow consumers options to obtain MDA output results either by pulling or pushing mechanisms. Any MDA output may be obtained once it is prepared or when the specified MDA request and control conditions are met.

### Streaming Data Reporting Service

establishStreamingConnection operation: This operation enables the MnS producer to establish a connection to the MnS consumer (i.e., streaming target). The connection establishment includes the exchange of metadata (producer informs consumer about its own identity and the nature of the data to be reported via streaming) phase and the actual connection (a data pipe for streaming) establishment.

Established connection supports stream multiplexing (one connection supports one or more reporting streams simultaneously).

Upon successful connection establishment, the MnS consumer is aware of the MnS producer's identity, the list of reporting streams and the nature of data being reported on each of the streams.

The established connection may be kept “alive” either by built-in functionality of the solution set or by periodic reporting of empty stream data.

Input parameters

| Parameter | | Information | |
|---|---|---|---|
| Name | S | type | Comment |
| producerId | M | The identity of the | DN of the MnS producer. If the MnS producer |
| | | producer requesting | is not modeled as 3GPP NRM MOI, an |
| | | the connection | alternative identifer other than DN may be |
| | | establishment. | used. |
| streamInfoList | M | List of | This parameter contains the list of meta-data |
| | | StreamInfo | about each reporting stream. |
| | | | For streaming trace reporting each StreamInfo |
| | | | includes: |
| | | | StreamTypecarrying the value “TRACE”; |
| | | | SerializationFormatcarrying the value |
| | | | “GPB” or “ASN1”; |
| | | | Trace Reference (see clause 5.6 of TS |
| | | | 32.422 [38]) as stream identifier; |
| | | | TraceJob (see clause 4.3.30 of TS 28.622 |
| | | | [11]) providing the details about the |
| | | | configuration of the trace job for which the |
| | | | data is being reported. |
| | | | For streaming performance data reporting each |
| | | | StreamInfo includes: |
| | | | StreamTypecarrying the value |
| | | | “PERFORMANCE”; |
| | | | SerializationFormatcarrying the value |
| | | | “GPB” or “ASN1”; |
| | | | streamIdglobally unique stream identifier; |
| | | | measObjDn: the DN of the measured |
| | | | object instance; |
| | | | performanceMetrics: a list of |
| | | | performance metric names whose values |
| | | | are to be reported by the Performance Data |
| | | | Stream Units (see Annex C of TS 28.550 |
| | | | [42]) via this stream. |
| | | | Performance metrics include measurement |
| | | | and KPI; |
| | | | either: |
| | | | jobId defined in the PerfMetricJob |
| | | | MOI (see clause 4.3.31 of TS 28.622 |
| | | | [11]) for which the data is being reported; |
| | | | or: |
| | | | jobIdglobally unique identifier of a |
| | | | measurement job (see TS 28.550 [42]). |
| | | | For streaming analytics reporting each |
| | | | StreamInfoincludes: |
| | | | StreamTypecarrying the value |
| | | | “ANALYTICS”; |
| | | | SerializationFormatcarrying the value |
| | | | “GPB” or “ASN1”; |
| | | | streamIdglobally unique stream identifier; |
| | | | AnalyticsInfoproviding the details |
| | | | about the analytics activity for which |
| | | | the data is being reported. |
| | | | For proprietary data streaming reporting each |
| | | | StreamInfoincludes: |
| | | | StreamTypecarrying the value |
| | | | “PROPRIETARY”; |
| | | | streamIdglobally unique stream identifier; |
| | | | VsDataContainer(see clause 4.3.9 of TS |
| | | | 28.622 [11]) providing the details |
| | | | about the data being reported. |

Output parameters

| Parameter | | Matching | |
|---|---|---|---|
| Name | S | Information | Comment |
| connectionId | M | Identifier of | It identifies the established streaming |
| | | the established | connection. The format may have |
| | | streaming | dependency on the solution set. |
| | | connection. | |
| status | M | ENUM | An operation may fail because of a |
| | | (Success, | specified or unspecified reason. |
| | | Failure) | |

terminateStreamingConnection Operation:

This operation enables the MnS producer to terminate the connection to the MnS consumer (i.e., streaming target).

Upon successful termination of the streaming connection, the MnS producer stops reporting data to the MnS consumer on this connection.

Input parameters

| Parameter | | Information | |
|---|---|---|---|
| Name | S | type | Comment |
| connectionId | M | See clause | It identifies the streaming connection |
| | | 11.5.1.1.3 | being terminated. The format may have |
| | | | dependency on the solution set. |

Output parameters

| Parameter | | Matching | |
|---|---|---|---|
| Name | S | Information | Comment |
| status | M | ENUM | An operation may fail because of |
| | | (Success, | a specified or unspecified reason. |
| | | Failure) | |

reportStreamData Operation:

This operation enables the MnS producer to send a unit of streaming data to the MnS consumer.

Input parameters

| Parameter | | Information | |
|---|---|---|---|
| Name | S | type | Comment |
| connectionId | M | See clause | It identifies the streaming connection on which |
| | | 11.5.1.1.3 | the reported data are being sent. The format |
| | | | may have dependency on the solution set. |
| streamingData | M | Unit of | This parameter contains the actual data |
| | | streaming | (payload) being reported via stream. |
| | | data | For streaming trace reporting each |
| | | | streamingDatais encoded according to the |
| | | | format specified in the clause 5 of 3GPP TS |
| | | | 32.423 [39]. |
| | | | For streaming performance data reporting each |
| | | | streamingDatais encoded according to the |
| | | | format specified in the Annex C of 3GPP TS |
| | | | 28.550 [42]. |
| | | | For proprietary data streaming reporting each |
| | | | streamingDatais encoded according to the |
| | | | format specified in the product documentation. |

Output parameters

| Parameter | | Matching | |
|---|---|---|---|
| Name | S | Information | Comment |
| status | M | ENUM | An operation may fail because of a |
| | | (Success, | specified or unspecified reason. |
| | | Failure) | |

addStream Operation

This operation allows the MnS producer to add one or more reporting streams to an already established streaming connection.

Input parameters

| Parameter | | Information | |
|---|---|---|---|
| Name | S | type | Comment |
| connectionId | M | See clause | It identifies the streaming connection to which |
| | | 11.5.1.1.3 | new reporting streams are being added. The |
| | | | format may have dependency on the solution set. |
| streamInfoList | M | List of | This parameter contains the list of meta-data |
| | | StreamInfo | about each reporting stream being added to the |
| | | | already established connection. |
| | | | For streaming trace reporting each StreamInfo |
| | | | includes: |
| | | | StreamTypecarrying the value “TRACE”; |
| | | | SerializationFormatcarrying the value |
| | | | “GPB” or “ASN1”; |
| | | | Trace Reference (see clause 5.6 of TS |
| | | | 32.422 [38]) as stream identifier; |
| | | | TraceJob (see clause 4.3.30 of TS 28.622 |
| | | | [11]) providing the details about the |
| | | | configuration of the trace job for which the |
| | | | data is being reported. |
| | | | For streaming performance data reporting each |
| | | | StreamInfo includes: |
| | | | StreamTypecarrying the value |
| | | | “PERFORMANCE”; |
| | | | SerializationFormatcarrying the value |
| | | | “GPB” or “ASN1”; |
| | | | streamIdglobally unique stream identifier; |
| | | | measObjDn: the DN of the measured |
| | | | object instance; |
| | | | performanceMetrics: a list of performance |
| | | | metric (i.e., measurement or KPI) names whose |
| | | | values are to be reported by the |
| | | | Performance Data Stream Units (see Annex C |
| | | | of TS 28.550 [42]) via this stream; |
| | | | either: |
| | | | jobId defined in the PerfMetricJob MOI |
| | | | (see clause 4.3.31 of TS 28.622 [11]) |
| | | | for which the data is being reported; |
| | | | or: |
| | | | jobIdglobally unique identifier of a |
| | | | measurement job (see TS 28.550 [42]). |
| | | | For streaming analytics reporting each |
| | | | StreamInfoincludes: |
| | | | StreamTypecarrying the value |
| | | | “ANALYTICS”; |
| | | | SerializationFormatcarrying the value |
| | | | “GPB” or “ASN1”; |
| | | | streamIdglobally unique stream identifier; |
| | | | AnalyticsInfoproviding the details |
| | | | about the analytics activity for which |
| | | | the data is being reported. |
| | | | For proprietary data streaming reporting each |
| | | | StreamInfoincludes: |
| | | | StreamTypecarrying the value |
| | | | “PROPRIETARY”; |
| | | | streamIdglobally unique stream identifier; |
| | | | VsDataContainer(see clause 4.3.9 of TS |
| | | | 28.622 [11]) |
| | | | providing the details about the data being |
| | | | reported. |

Output parameters

| Parameter | | Matching | |
|---|---|---|---|
| Name | S | Information | Comment |
| streamInfoList | M | List of | This parameter contains the list of meta-data |
| | | StreamInfo | about each reporting stream being added to |
| | | | the already established connection. |
| | | | For streaming trace reporting each |
| | | | StreamInfoincludes: |
| | | | StreamTypecarrying the value |
| | | | “TRACE”; |
| | | | SerializationFormatcarrying the value |
| | | | “GPB” or “ASN1”; |
| | | | Trace Reference (see clause 5.6 of TS |
| | | | 32.422 [38]) as stream identifier; |
| | | | TraceJob (see clause 4.3.30 of TS |
| | | | 28.622 [11]) providing the details about |
| | | | the configuration of the trace job for |
| | | | which the data is being reported. |
| | | | For streaming performance data reporting |
| | | | each StreamInfo includes: |
| | | | StreamTypecarrying the value |
| | | | “PERFORMANCE”; |
| | | | SerializationFormatcarrying the value |
| | | | “GPB” or “ASN1”; |
| | | | streamIdglobally unique stream |
| | | | identifier; |
| | | | measObjDn: the DN of the measured |
| | | | object instance; |
| | | | performanceMetrics: a list of performance |
| | | | metric (i.e., measurement or KPI) names |
| | | | whose values are to be reported by the |
| | | | Performance Data Stream Units (see Annex |
| | | | C of TS 28.550 [42]) via this stream; |
| | | | either: |
| | | | jobId defined in the PerfMetricJob MOI |
| | | | (see clause 4.3.31 of TS 28.622 [11]) |
| | | | for which the data is being reported; |
| | | | or: |
| | | | jobIdglobally unique identifier of a |
| | | | measurement job (see TS 28.550 [42]). |
| | | | For streaming analytics reporting each |
| | | | StreamInfoincludes: |
| | | | StreamTypecarrying the value |
| | | | “ANALYTICS”; |
| | | | SerializationFormatcarrying the value |
| | | | “GPB” or “ASN1”; |
| | | | streamIdglobally unique stream |
| | | | identifier; |
| | | | AnalyticsInfoproviding the details |
| | | | about the analytics activity for |
| | | | which the data is being reported. |
| | | | For proprietary data streaming reporting |
| | | | each StreamInfoincludes: |
| | | | StreamTypecarrying the value |
| | | | “PROPRIETARY”; |
| | | | streamIdglobally unique stream |
| | | | identifier; |
| | | | VsDataContainer(see clause 4.3.9 of TS |
| | | | 28.622 [11]) |
| | | | providing the details about the data being |
| | | | reported. |
| status | M | ENUM | An operation may fail because of a |
| | | (Success, | specified or unspecified reason. |
| | | Failure) | |

deleteStream Operation

This operation allows the MnS producer to remove one or more reporting streams from an already established streaming connection.

Input parameters

| Parameter | | Information | |
|---|---|---|---|
| Name | S | type | Comment |
| connectionId | M | See clause | It identifies the streaming connection from |
| | | 11.5.1.1.3 | which the reporting streams are being |
| | | | removed. The format may have dependency on |
| | | | the solution set. |
| streamInfoList | M | List of | This parameter contains the list of identifiers |
| | | StreamInfo | for streams being removed from the already |
| | | | established connection. |
| | | | For streaming trace reporting Trace Reference |
| | | | (see clause 5.6 of 3GPP TS 32.422 [38]) is |
| | | | used as stream identifier. |
| | | | For streaming performance data reporting |
| | | | streamIdglobally unique stream identifier. |
| | | | For streaming analytics reporting streamId |
| | | | globally unique stream identifier. |
| | | | For proprietary data streaming reporting |
| | | | streamIdglobally unique stream identifier. |

Output parameters

| Parameter | | Matching | |
|---|---|---|---|
| Name | S | Information | Comment |
| status | M | ENUM | An operation may fail because of a |
| | | (Success, | specified or unspecified reason. |
| | | Failure) | |

Notification notifyFileReady

A MnS producer sends this notification to subscribed MnS consumers when a new file becomes ready (available) on the MnS producer for upload by MnS consumers. The “fileInfoList” parameter provides information (meta data) about the new file and optionally, in addition to that, information about all other files, which became ready for upload earlier and are still available for upload when the notification is sent.

The “objectClass” and “objectInstance” parameters of the notification header identify the object representing the function (process) making the file available for retrieval, such as the “PerfMetricJob” or the “TraceJob” defined in TS 28.622 [11]. When no dedicated object is standardized or instantiated, the “ManagedElement”, where the file is processed, shall be used. For the case that the file is processed on a management node, the “ManagementNode”, where the file is processed, shall be used instead.

Input parameters

| Parameter | | Information | |
|---|---|---|---|
| Name | S | type | Comment |
| objectClass | M | Entity.objectClass | See clause 11.6.1.1.1 |
| | | | for the definition |
| | | | of Entity |
| objectInstance | M | Entity.objectInstance | See clause 11.6.1.1.1 |
| | | | for the definition |
| | | | of Entity |
| notificationId | M | — | |
| notificationType | M | “notifyFileReady” | |
| systemDN | M | | |
| fileInfoList | M | List of struct<fileLocation (M), | Information (meta |
| | | fileCompression (M), fileSize (O), | data) about the |
| | | fileDataType (M), fileFormat (M), | new file, that |
| | | fileReadyTime (O), fileExpirationTime (O), | became ready for |
| | | . . . jobId (CO) | upload and |
| | | Each element is defined as following: | triggered this |
| | | “fileLocation”: Location of the file. The location | notification, and |
| | | may be a directory path or a URL, for example | information about |
| | | “\\202.112.101.1\D:\user\Files\<xxx>”, or | files, which |
| | | “ftp://nms.telecom_org.com/datastore/<xxx>, | became ready for |
| | | where <xxx> is the filename. | upload earlier |
| | | “fileCompression”: Name of the algorithm used | and are still |
| | | for compressing the file. An empty or absent | available for |
| | | “fileCompression” parameter indicates the file is | upload when the |
| | | not compressed. The MnS producer selects the | notification |
| | | compression algorithm. It is encouraged to use | is sent. |
| | | popular algorithms such as GZIP. | |
| | | “fileSize”: Size of the file. Its value is a non | |
| | | negative integer. The unit is byte. | |
| | | “fileDataType”: Type of the management data | |
| | | stored in the file. Allowed values are: | |
| | | “PERFORMANCE” | |
| | | “TRACE” | |
| | | “ANALYTICS” | |
| | | “PROPRIETARY” | |
| | | The value “PERFORMANCE” refers to | |
| | | measurements and KPIs. | |
| | | “fileFormat”: Identifier of the XML or ASN.1 | |
| | | schema (incl. its version) used to produce the file | |
| | | content. | |
| | | “fileReadyTime”: Date and time when the file was | |
| | | closed (the last time) and made available on the | |
| | | MnS producer. The file content will not be | |
| | | changed anymore. | |
| | | “fileExpirationTime”: Date and time after which the | |
| | | file may be deleted. It shall not be empty and shall be | |
| | | later than “fileReadyTime”. | |
| | | “jobId”: Job identifier of the “PerfMetricJob” (TS | |
| | | 28.622 [11]) or “TraceJob” (TS 28.622 [11]) that | |
| | | produced the file. This parameter should be present, | |
| | | when the file is related to a job and that job is | |
| | | represented by a “PerfMetricJob” or “TraceJob” | |
| | | Multiple jobs may share the same job identifier. This | |
| | | may for example be the case for jobs collecting | |
| | | measurements to compuate a KPI or for jobs related | |
| | | to a specific task in some analytics application. Note | |
| | | that a specific job is identified by the | |
| | | objectClass/objectInstance parameters of the | |
| | | notification header. | |
| additionalText | O | — | Allows a free form |
| | | | text description |
| | | | to be reported |
| | | | as defined in ITU-T |
| | | | Rec. X. 733 [4] |

### Operation Subscribe

This operation allows a MnS consumer to subscribe to the notifications of the file data reporting service producer.

Input parameters

| | | | |
|---|---|---|---|
| Parameter Name | S | Information type | Comment |

| | | |
|---|---|---|
| consumerReference | M | Reference (address) of the MnS consumer to |
| | | which the notifications shall be sent. |
| timeTick | O | Initial value of a timer held by the MnS |
| | | producer. This value defines the time window |
| | | within which the MnS consumer intends to |
| | | invoke the “subscribe” operation again to |
| | | confirm its subscription. The value “0” shall |
| | | indicate infinity. In this case the subscription |
| | | is not terminated by the MnS producer. |
| | | Unit is minutes |
| filter | O | Filter constraint that the MnS producer shall |
| | | use to filter notifications. The filter can be |
| | | applied to all parameters of a notification. |
| | | The filter constraint grammar is solution set |
| | | dependent |

Output parameters

| Parameter | | Matching | |
|---|---|---|---|
| Name | S | Information | Comment |
| subscriptionId | M | Unambiguous identity of this | |
| | | subscription. | |
| status | M | ENUM (OperationSucceeded, | If subscription is successfully |
| | | OperationFailedExistingSubscription, | created, status = OperationSuceeded. |
| | | OperationFailed) | If subscription is not created |
| | | | because it is duplicated or conflict |
| | | | with existing subscription(s), status = |
| | | | OperationFailedExistingSubscription |
| | | | If the operation is failed for any |
| | | | other reason than being duplicated |
| | | | or conflict with existing subscription(s), |
| | | | status = OperationFailed. |

Notification notifyMOICreation

This notification notifies the subscribed consumers that a new Managed Object Instance has been created.

Input parameters

| Parameter | | Information type/Legal | |
|---|---|---|---|
| Name | S | Values | Comment |
| objectClass | M | It shall carry the | It specifies the class name of the |
| | | ManagedEntity | IOC. A network event has |
| | | class name. | occurred in an instance of this |
| | | | class. |
| objectInstance | M | It shall carry the DN of the | It specifies a new instance of the |
| | | ManagedEntity. | above IOC in which the network |
| | | | event related to by carrying the |
| | | | Distinguished Name (DN) for the |
| | | | instance. |
| notificationId | M | This is an identifier for the | The identifier of the notification |
| | | notification, which may be | shall be chosen to be unique |
| | | used to correlate | across all notifications of a |
| | | notifications. | particular managed object |
| | | | instance throughout the time that |
| | | | correlation is significant, it |
| | | | uniquely identifies the |
| | | | notification from other |
| | | | notifications generated by the |
| | | | subject MOI |
| notificationType | M | It specifies the type of | It specifies the type of |
| | | provisioning management | notification |
| | | services related notifications. | |
| | | The value | |
| | | “notifyMOICreation” shall be | |
| | | carried. | |
| eventTime | M | It indicates the MOICreation | The semantics of Generalised |
| | | event time. | Time specified by ITU-T[17] |
| | | | shall be used here |
| systemDN | M | It shall carry the DN of | — |
| | | management service providers. | |
| correlatedNotifications | C | It specifies a set of | The condition is that the MnS |
| | M | notifications that | producer support the correlation |
| | | are correlated to the subject | of notifications |
| | | notification | |
| additionalText | O | It can contain further | — |
| | | information in text on the | |
| | | event of theManagedEntity(s). | |
| sourceIndicator | O | ENUM(Resource_operation, | This parameter, when present, |
| | | Management_operation, | indicates the source of the |
| | | SON_operation, Unknown) | operation that led to |
| | | | the generation of this |
| | | | notification. It can have one of |
| | | | the following values: |
| | | | 1. resource operation: The |
| | | | notification was generated in |
| | | | response to an internal operation |
| | | | of the resource; |
| | | | 2. management operation: The |
| | | | notification was generated in |
| | | | response to a management |
| | | | operation applied across the |
| | | | managed object boundary |
| | | | external to the managed object; |
| | | | 3. SON operation: The |
| | | | notification was generated as |
| | | | result of a SON (Self |
| | | | Organising Network) process |
| | | | like self- configuration, self- |
| | | | optimization, self- healing etc.. |
| | | | 4. unknown: It is not possible to |
| | | | determine the source of the |
| | | | operation. |
| | | | Remark: A provisioning MnS |
| | | | provider may not in any case be |
| | | | aware that SON operation lead |
| | | | to the generation of this |
| | | | generation. In this case another |
| | | | value than SON_operation for |
| | | | sourceIndicator might be sent. |
| attributeList | O | LIST OF SEQUENCE | The attributes (name/value |
| | | <AttributeName, | pairs) of the created MOI |
| | | AttributeValue> | |

### Examples

Example 1 is an apparatus of a management system, the apparatus comprising: processing circuitry configured to operate as a Management Data Analytics Service (MDAS) producer to: receive a request from an MDAS consumer to create a Managed Object Instance (MOI) for an MDA request; create the MOI for the MDA request; perform MDA while the MDA request is active; create an MDA report based on the MDA; and send the MDA report to a reporting target per a reporting method selected from a plurality of reporting methods; and memory configured to store the MDA report.

In Example 2, the subject matter of Example 1 includes, wherein the processing circuitry is further configured to establish the reporting method by at least one of: subscription to notifications for the reporting target; or setup of a streaming connection with the reporting target.

In Example 3, the subject matter of Examples 1-2 includes, wherein the MOI is an instance of an MDARequest Information Object Class (IOC).

In Example 4, the subject matter of Example 3 includes, wherein the processing circuitry is further configured to determine the reporting method from a reportingMethod attribute in an MDARequest MOI.

In Example 5, the subject matter of Examples 3-4 includes, wherein the processing circuitry is further configured to determine the reporting target from a reportingTarget attribute in an MDARequest MOI.

In Example 6, the subject matter of Examples 1-5 includes, wherein the plurality of reporting methods includes “File”, in which the processing circuitry is configured to make the MDA report into a file, “Streaming”, in which the processing circuitry is configured to make the MDA report into a stream data unit, and “Notification”, in which the processing circuitry is configured to create an MDAReport MOI for the MDA report.

In Example 7, the subject matter of Examples 1-6 includes, wherein the processing circuitry is further configured to create a subscription for the reporting target based on the reporting method, and the subscription is at least one of file data reporting-related notifications or provisioning-related notifications.

In Example 8, the subject matter of Examples 1-7 includes, wherein the processing circuitry is further configured to: determine whether a streaming connection with the reporting target exists; and in response to a determination that the streaming connection with the reporting target does not exist, establish the streaming connection with the reporting target using an establishStreamingConnection operation to setup the streaming connection with the reporting target.

In Example 9, the subject matter of Examples 1-8 includes, wherein the processing circuitry is further configured to add a first stream to the reporting target to provide the MDA report to the reporting target.

In Example 10, the subject matter of Example 9 includes, wherein the processing circuitry is further configured to: determine whether the first stream is to replace a second stream; and delete the second stream to the reporting target after addition of the first stream in response to a determination that the first stream is to replace the second stream.

In Example 11, the subject matter of Example 10 includes, wherein the processing circuitry is further configured to use an addStream operation to add the first stream and use a deleteStream operation to delete the second stream.

In Example 12, the subject matter of Examples 1-11 includes, wherein the processing circuitry is further configured to send the MDA report to the reporting target via a notifyFileReady notification.

In Example 13, the subject matter of Examples 1-12 includes, wherein the processing circuitry is further configured to send the MDA report to the reporting target via a reportStreamData operation.

In Example 14, the subject matter of Examples 1-13 includes, wherein the processing circuitry is further configured to send the MDA report to the reporting target via a notifyMOICreation notification or notifyMOIChanges notification.

Example 15 is a non-transitory computer-readable storage medium that stores instructions for execution by one or more processors of Management Data Analytics Service (MDAS) producer, the one or more processors to configure the MDAS to, when the instructions are executed: receive a request from an MDAS consumer to create a Managed Object Instance (MOI) for an MDA request; create the MOI for the MDA request; perform MDA while the MDA request is active; subscribe to notifications based on a reporting method selected from a plurality of reporting methods that include, “File”, “Streaming”, and “Notification”; create an MDA report based on the MDA; and send the MDA report in a file for the reporting method “File”, a stream data unit for the reporting method “Streaming”, and an MDAReport MOI for the reporting method “Notification”.

In Example 16, the subject matter of Example 15 includes, wherein the MOI is an instance of an MDARequest Information Object Class (IOC), and the one or more processors to configure the MDAS producer to, when the instructions are executed, determine the reporting method from a reportingMethod attribute in an MDARequest MOI and determine the reporting target from a reportingTarget attribute in the MDARequest MOI.

In Example 17, the subject matter of Examples 15-16 includes, wherein the one or more processors to configure the MDAS producer to, when the instructions are executed, create a subscription for the reporting target based on the reporting method, and the subscription is selected from a group of subscriptions that include file data reporting-related notifications and provisioning-related notifications.

In Example 18, the subject matter of Examples 15-17 includes, wherein the one or more processors to configure the MDAS producer to, when the instructions are executed, add a stream to the reporting target using an addStream operation. send the MDA report to the reporting target via at least one of a notifyFileReady notification or a reportStreamData operation.

Example 19 is an apparatus of a management system, the apparatus comprising: processing circuitry configured to operate as a Management Data Analytics Service (MDAS) reporting target to receive, per a reporting method selected from a plurality of reporting methods that include, file, streaming, and notification, an MDA report containing MDA data after creation of a Managed Object Instance (MOI) for an MDA request, the MDA report sent in a file for a reporting method “File”, a stream data unit for a reporting method “Streaming”, and an MDAReport MOI for a reporting method “Notification”; and memory configured to store the MDA report.

In Example 20, the subject matter of Example 19 includes, wherein the reporting method is based on one of a file data reporting-related notification or provisioning-related notification and the MDA report is received via one of a notifyFileReady notification or a reportStreamData operation.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-20. (canceled)

21. An apparatus of a management system, the apparatus comprising:
processing circuitry configured to operate as a Management Data Analytics Service (MDAS) producer to:
receive a request from an MDAS consumer to create a Managed Object Instance (MOI) for a Management Data Analytics (MDA) request;
create the MOI for the MDA request;
perform MDA while the MDA request is active;
create an MDA report based on the MDA; and
send the MDA report to a reporting target per a reporting method selected from a plurality of reporting methods; and
memory configured to store the MDA report.

22. The apparatus of claim 21, wherein the processing circuitry is further configured to establish the reporting method by at least one of:
subscription to notifications for the reporting target; or
setup of a streaming connection with the reporting target.

23. The apparatus of claim 21, wherein the MOI is an instance of an MDARequest Information Object Class (IOC).

24. The apparatus of claim 23, wherein the processing circuitry is further configured to determine the reporting method from a reportingMethod attribute in an MDARequest MOI.

25. The apparatus of claim 23, wherein the processing circuitry is further configured to determine the reporting target from a reportingTarget attribute in an MDARequest MOI.

26. The apparatus of claim 21, wherein the plurality of reporting methods includes “File”, in which the processing circuitry is configured to make the MDA report into a file, “Streaming”, in which the processing circuitry is configured to make the MDA report into a stream data unit, and “Notification”, in which the processing circuitry is configured to create an MDAReport MOI for the MDA report.

27. The apparatus of claim 21, wherein the processing circuitry is further configured to create a subscription for the reporting target based on the reporting method, and the subscription is at least one of file data reporting-related notifications or provisioning-related notifications.

28. The apparatus of claim 21, wherein the processing circuitry is further configured to:
determine whether a streaming connection with the reporting target exists; and
in response to a determination that the streaming connection with the reporting target does not exist, establish the streaming connection with the reporting target using an establishStreamingConnection operation to setup the streaming connection with the reporting target.

29. The apparatus of claim 21, wherein the processing circuitry is further configured to add a first stream to the reporting target to provide the MDA report to the reporting target.

30. The apparatus of claim 29, wherein the processing circuitry is further configured to:
determine whether the first stream is to replace a second stream; and
delete the second stream to the reporting target after addition of the first stream in response to a determination that the first stream is to replace the second stream.

31. The apparatus of claim 30, wherein the processing circuitry is further configured to use an addStream operation to add the first stream and use a deleteStream operation to delete the second stream.

32. The apparatus of claim 21, wherein the processing circuitry is further configured to send the MDA report to the reporting target via a notifyFileReady notification.

33. The apparatus of claim 21, wherein the processing circuitry is further configured to send the MDA report to the reporting target via a reportStreamData operation.

34. The apparatus of claim 21, wherein the processing circuitry is further configured to send the MDA report to the reporting target via a notifyMOICreation notification or notifyMOIChanges notification.

35. A non-transitory computer-readable storage medium that stores instructions for execution by one or more processors of Management Data Analytics Service (MDAS) producer, the one or more processors to configure the MDAS producer to, when the instructions are executed:
receive a request from an MDAS consumer to create a Managed Object Instance (MOI) for a Management Data Analytics (MDA) request;
create the MOI for the MDA request;
perform MDA while the MDA request is active;
subscribe to notifications based on a reporting method selected from a plurality of reporting methods that include “File”, “Streaming”, and “Notification”;
create an MDA report based on the MDA; and
send, to a reporting target, the MDA report in a file for the reporting method “File”, a stream data unit for the reporting method “Streaming”, and an MDAReport MOI for the reporting method “Notification”.

36. The non-transitory computer-readable storage medium of claim 35, wherein the MOI is an instance of an MDARequest Information Object Class (IOC), and the one or more processors to configure the MDAS producer to, when the instructions are executed, determine the reporting method from a reportingMethod attribute in an MDARequest MOI and determine the reporting target from a reporting Target attribute in the MDARequest MOI.

37. The non-transitory computer-readable storage medium of claim 35, wherein the one or more processors to configure the MDAS producer to, when the instructions are executed, create a subscription for the reporting target based on the reporting method, and the subscription is selected from a group of subscriptions that include file data reporting-related notifications and provisioning-related notifications.

38. The non-transitory computer-readable storage medium of claim 35, wherein the one or more processors to configure the MDAS producer to, when the instructions are executed, add a stream to the reporting target using an addStream operation. send the MDA report to the reporting target via at least one of a notifyFileReady notification or a reportStreamData operation.

39. An apparatus of a management system, the apparatus comprising:
processing circuitry configured to operate as a Management Data Analytics Service (MDAS) reporting target to receive, per a reporting method selected from a plurality of reporting methods that include file, streaming, and notification, a Management Data Analytics (MDA) report containing MDA data after creation of a Managed Object Instance (MOI) for an MDA request, the MDA report sent in a file for a reporting method “File”, a stream data unit for a reporting method “Streaming”, and an MDAReport MOI for a reporting method “Notification”; and
memory configured to store the MDA report.

40. The apparatus of claim 39, wherein the reporting method is based on one of a file data reporting-related notification or provisioning-related notification and the MDA report is received via one of a notifyFileReady notification or a reportStreamData operation.
